(19) United States
(12) Patent Application Publication
(10) Pub. No.: US 2007/0130730 A1
(43) Pub. Date: Jun. 14, 2007

(54) HINGE ASSEMBLY FOR DOOR OF LAUNDRY DEVICE

(76) Inventors: Han Ki Cho, Gimhae-si (KR); Jong Sun Yoon, Jinju-si (KR); Ho Sung Jang, Hadong-gun (KR); Chang Woo Son, Gimhae-si (KR); Dong Min Kim, Dong-gu (KR); Jae Cheol Lyu, Changwon-si (KR)

Correspondence Address: KED & ASSOCIATES, LLP, P.O. Box 221200, Chantilly, VA, 20153-1200, US

(21) Appl. No.: 11/536,264

(22) Filed: Sep. 28, 2006

(30) Foreign Application Priority Data
Sep. 30, 2005 (KR) 10-2005-0092248

(51) Int. Cl. E05D 5/02

(52) U.S. Cl. 16/387

(57) ABSTRACT

A hinge assembly for a door of a laundry device is disclosed. A hinge assembly for a door of a laundry device which has a bracket fixed to a cabinet and a hinge arm having a first end rotatably connected to the bracket and a second end connected to a door, wherein at least two fastening holes fastened to the cabinet by a fastening unit are formed on an upper end portion and a lower end portion of the bracket, and the fastening holes of the lower end portion are formed at the same height. The fastening holes of the upper end portion are formed at the same height. An object of the present invention is to provide a hinge assembly for a door of a laundry device which can prevent damage or deformity thereof by dispersing the load of the door to each fastening portion of a hinge assembly.

### This application claims the benefit of the Patent Korean Application No. 10-2005-0092248, filed on Sep. 30, 2005, which is hereby incorporated by reference as if fully set forth herein.

### BACKGROUND OF THE INVENTION.

1. Field of the Invention

The present invention relates to a hinge assembly for a door of a laundry device, more particularly, to a hinge assembly to rotatably support a door of a laundry device such as a washing machine or a dryer.

2. Discussion of the Related Art

In general, a washing machine has a tub and a drum mounted therein, and washes laundries by rotating the tub and the drum. Like a washing machine, a dryer has a drum mounted therein to hold the laundry and dries the laundry by supplying hot air into the drum.

Here, a door is coupled to a cabinet of a washing machine and a dryer to load/unload the laundry from a washing machine and a dryer. The door is rotatably coupled to the cabinet to open/close an opening which communicates with the drum within the washing machine and the dryer. More specifically, the door is connected to a hinge assembly mounted to the cabinet and rotates about the hinge assembly to open/close the opening.

Referring to the drawings attached hereto, a conventional hinge assembly according to the prior art will be described.

FIG. 1 illustrates a structure of a conventional drum type washing machine as one example of a laundry device.

The drum type washing machine includes a cabinet 11, a tub 12 and a drum 13 mounted within the cabinet 11. The cabinet 11 is structured to mount and protect various components therein. The tub 12 preliminarily stores wash water therein to supply wash water to the drum 13 regularly. Also, the tub 12 is elastically fixed within the cabinet 11 by a suspension spring 11a and a damper 11b. The drum 13 holds wash water therein and is rotatably mounted within the tub 12. A plurality of through-holes 13b are formed on the drum 13 to drawn wash water there through and a plurality of lifters 13a are provided on an inner circumferential surface of the drum 13 to mix the laundry uniformly.

Meanwhile, a BLDC motor 14 of an outer rotor type is mounted in rear of the tub 12 to rotate the drum 13. The BLDC motor 14 includes a stator 14a fixed to a rear surface of the tub 12 and a rotor 14b directly connected to a rotation shaft 13c of the drum 13 to be rotated in an outer direction of the stator 14a.

An opening 15 is formed in front of the cabinet 11 to load/unload the laundry. The opening 15 is opened/closed by a door 30. The door 30 includes a door frame 32 having a ring shape, a door glass 33 fastened to an inside of the door frame 32. The door glass 33 is made of transparent material. Also, the door 30 is connected to a hinge assembly 100 fixed to a front surface of the cabinet 11 and rotated about the hinge assembly 100.

As shown in FIGS, 2 and 3, the hinge assembly 100 includes a bracket 110 fixed on an inner front surface of the cabinet 11 and a hinge arm 120 of a hook shape having a first end rotatably connected to the bracket 110 and a second end connected to the door.

The hinge arm 120 is rotatably connected to the bracket 110 by a hinge shaft 130. A connection shaft 122 is formed at an end of the hinge arm 120 to be connected to the door frame 32. The hinge arms 120 are connected to the door frame 32 through holes 16 formed on a front surface of the cabinet 11, such that the hinge arms 120 pass into/out of the holes 16 when the door 30 is rotated.

A plurality of fastening-holes 113 and 114 are formed on an upper corner, a lower corner, and a middle portion of the bracket 110 to fasten the bracket 110 to the cabinet 11 by using a screw 140.

Thus, as shown in FIG. 4, the bracket 110 (see FIG. 3) is fixed to the cabinet 11 by fastening the screw 140 through each fastening hole 113 and 114 of the bracket 110 from an outer surface of the cabinet 11, in a state of being contacted with an inner front surface of the cabinet 11.

However, the conventional drum type washing machine has a problem that the conventional hinge assembly fails to supply enough supporting strength to cause damage or deformity of the hinge assembly.

More specifically, the load of the door 30 is supported only by the bracket 110 in the conventional hinge assembly 100. Thus, the load of the door 30 is transmitted to the portion between the bracket 110 and the cabinet 11, which is fastened by the screw 140.

However, since the fastening holes 113 formed on the upper and lower portion of the bracket 110 are provided at a different height, the load of the door 30 is concentrated on the screw 140 fastened to each fastening hole 113. Due to the above concentration, there may be crack on the portion of the cabinet 11 or the hinge assembly 100 fastened by the screw 140, such that damage or deformity of the cabinet 11 or the bracket 110 may be caused. The damage or deformity may generated on the lowest portion of the bracket 110 fastened by the screw 140, because the lowest portion has the most concentrated load.

The above problem has been more and more serious, because recently the capacity of a drum type washing machine has been getting larger, resulting in enlarging the size of a door.

### SUMMARY OF THE INVENTION

Accordingly, the present invention is directed to a hinge assembly for a door of a laundry device.

An object of the present invention is to provide a hinge assembly for a door of a laundry device which can prevent damage or deformity thereof by dispersing the load of the door to each fastening portion of a hinge assembly.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a hinge assembly for a door of a laundry device which has a bracket fixed to a cabinet and a hinge arm having a first end rotatably connected to the bracket and a second end connected to a door, wherein at least two fastening holes fastened to the cabinet by a fastening unit are formed on an upper end portion and a lower end portion of the bracket, and the fastening holes of the lower end portion are formed at the same height.

Here, the fastening holes of the upper end portion may be formed at the same height.

In another aspect of the present invention, a hinge assembly for a door of a laundry which has a bracket fixed to a cabinet and a hinge arm having a first end rotatably connected to the bracket and a second end connected to a door, wherein at least two fastening holes fastened to the cabinet by a fastening unit are formed on an upper end portion and a lower end portion of the bracket, and the fastening holes of the upper end portion are formed at the same height.

Here, the fastening holes of the lower portion may be formed at the same height.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view illustrating key parts of a drum type washing machine which can apply a conventional hinge assembly for a door thereto.

FIG. 2 is a perspective view illustrating a hinge assembly for a door.

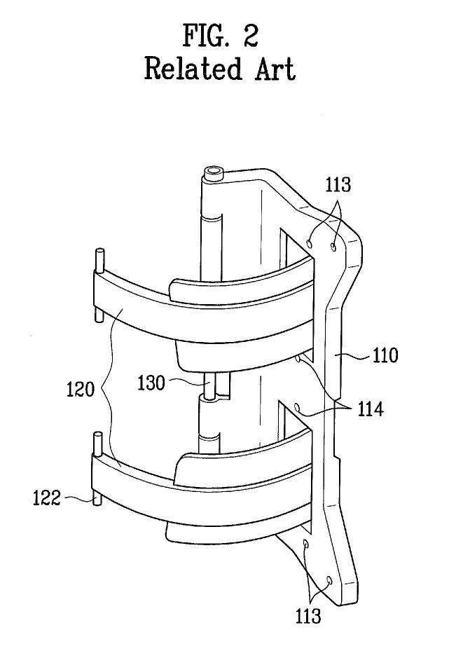

FIG. 3 is a perspective view illustrating the hinge assembly of FIG. 2 seen in front.

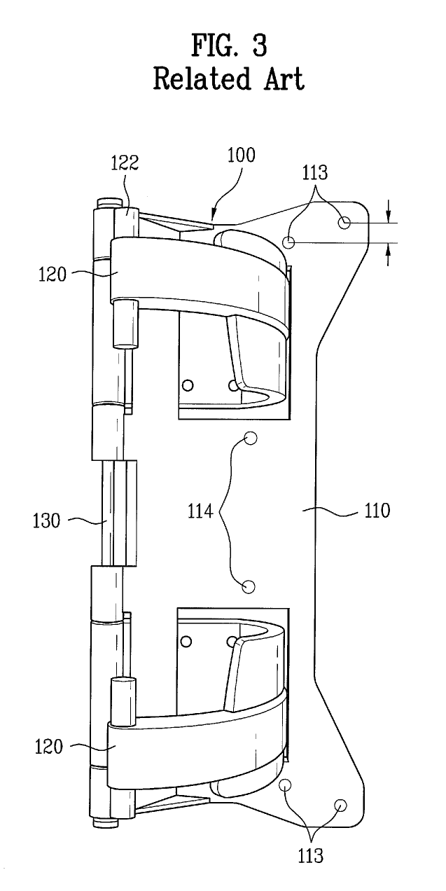

FIG. 4 is a partial perspective view illustrating that the conventional hinge assemble for a door is fastened to a door or a cabinet.

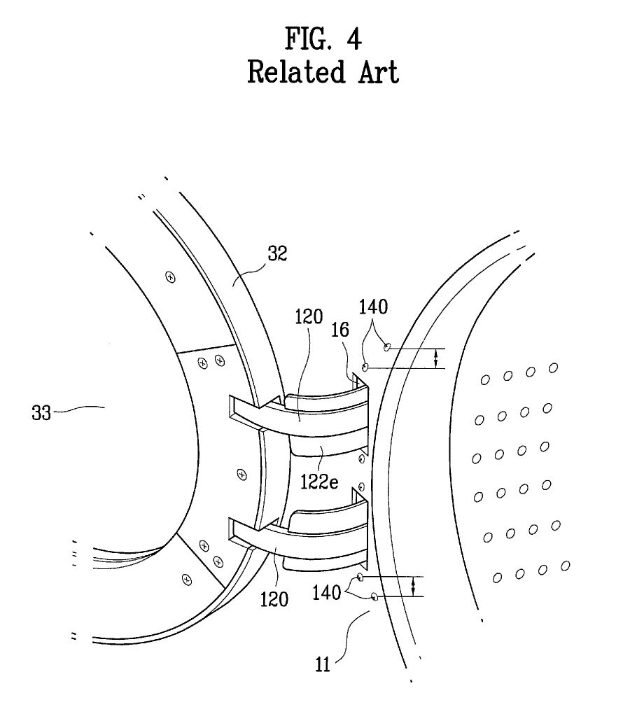

FIG. 5 is a horizontal sectional view illustrating a hinge door for a door according to the present invention fastened to a door and a cabinet.

FIG. 6 is an exploded perspective view illustrating an embodiment of the hinge assembly for a door according to the present invention.

FIG. 7 is a perspective view illustrating the hinge assembly of FIG. 6 seen in front.

FIG. 8 is a plane view illustrating the hinge assembly of FIG. 6.

FIG. 9 is a partial perspective view illustrating the hinge assembly of FIG. 6 fastened to a door and a cabinet.

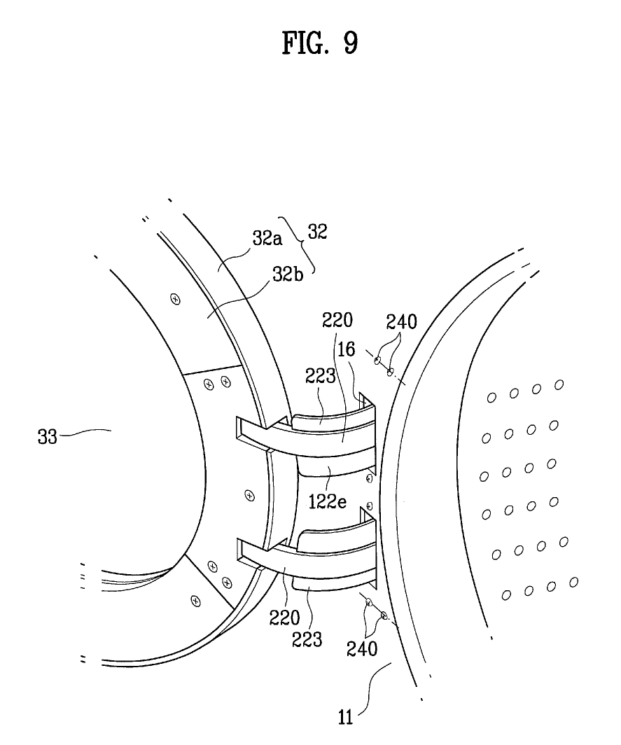

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

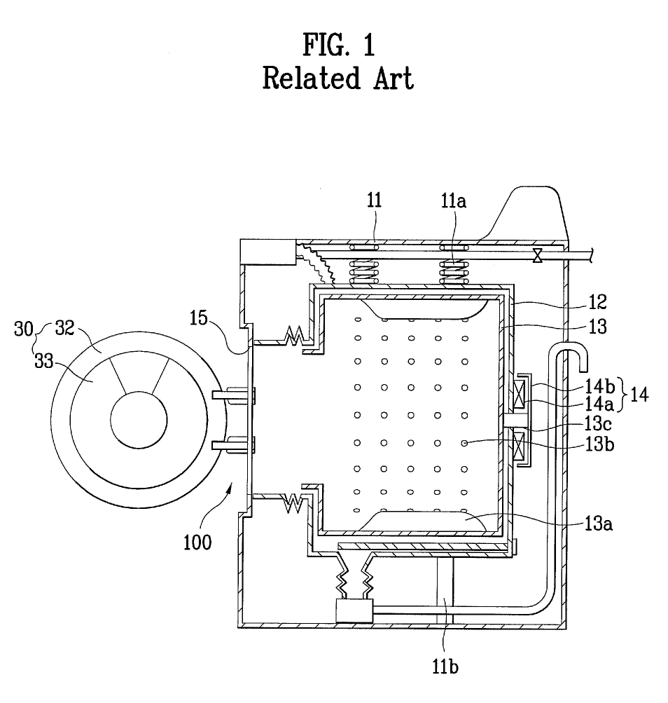

Referring to the drum type washing machine illustrated in FIG. 1, the configuration of the drum type washing machine will not be described.

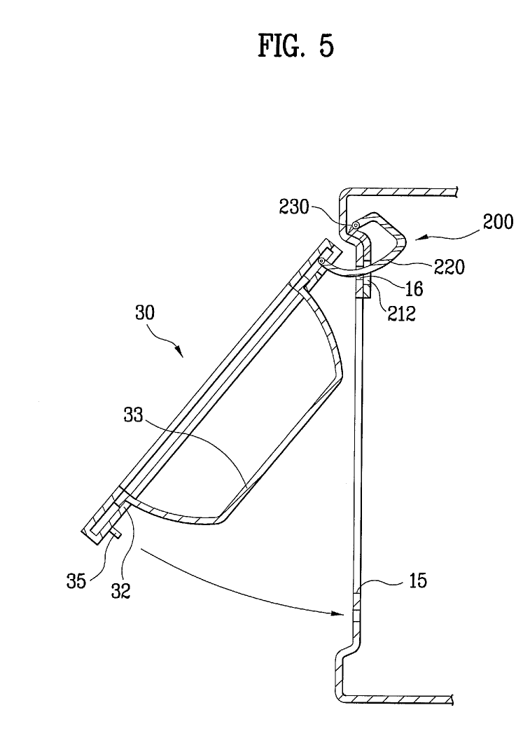

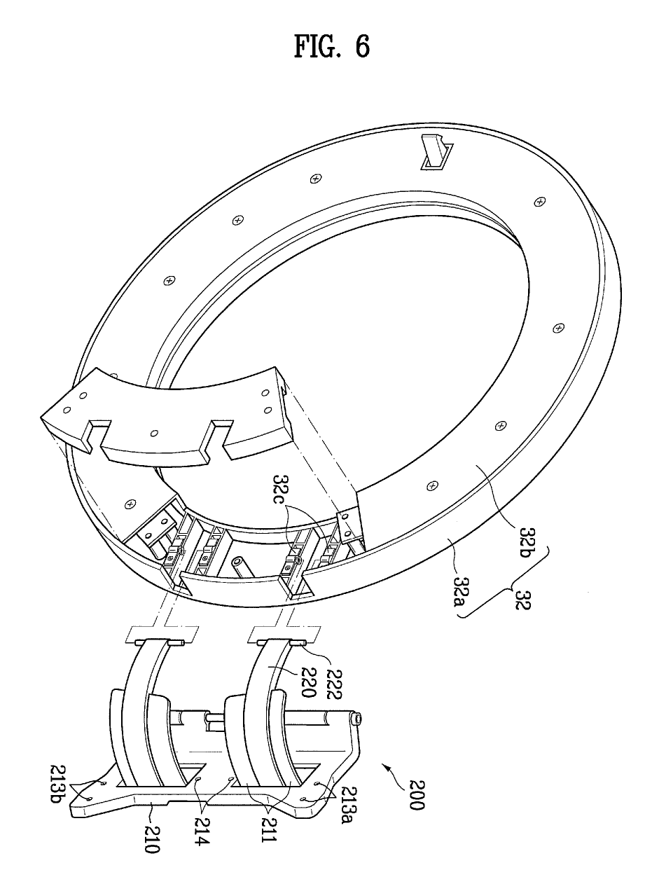

As shown in FIGS. 5 and 6, a door frame 32 fastening a hinge assembly 200 of the present invention thereto includes an outer frame 32a and an inner frame 32b. A hook 35 is formed at a first side of the door frame 32 and a fastening mechanism (not shown) is provided in a cabinet 11 to hold the hook. When a door 30 is closed, the hook is fastened to the fastening mechanism so that the door 30 may not be opened during the operation of the drum type washing machine.

Connection brackets 32c are fastened to an inside of the outer frame 32a to rotatably connect connection shafts 222 of the hinge assembly 200 thereto.

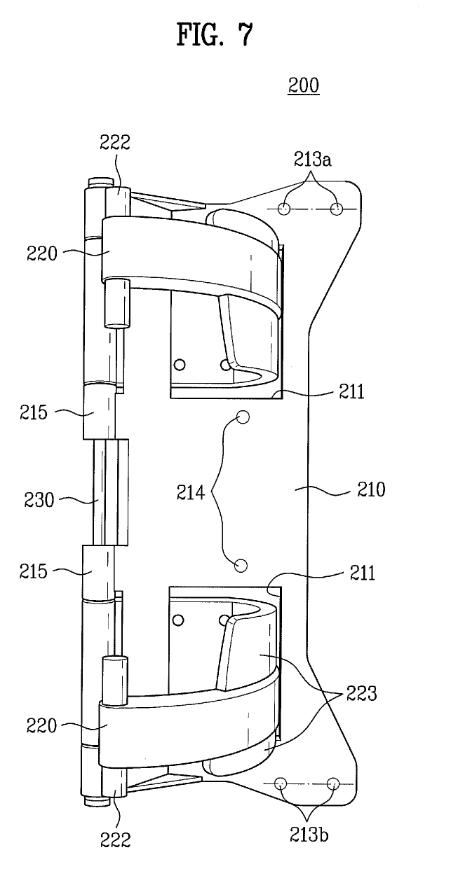

As shown in FIGS. 5 to 7, the hinge assembly 200 includes a bracket 210 and two hinge arms 220 having a hook shape. The bracket 210 is fixed to a front inner surface of a cabinet 11. The hinge art 220 has a first end rotatably connected to the bracket 210 and a second end connected to the door 30.

Each hinge arm 220 is connected to a bracket 210 by a hinge shaft 230 to rotate about a hinge shaft 230. A connection shaft 222 connected to the door frame 32 is extended at the second end of the hinge arm 220 in a longitudinal direction. The hinge arms 220 are connected to the door frame 32 through through-holes 16 formed on a front surface of the cabinet 11, and rotated through the through-holes 16 when the door 30 is rotated.

A rib 223 is extended on the hinge arm 220 in a longitudinal direction to reinforce strength.

An opening 211 is formed in the bracket 210 such that some of the hinge arms 220 may pass there through and rotate. Also, a hinge fastening parts 215 are formed at an end of the bracket 210 to insert the hinge shaft 230 therein.

A plurality of fastening holes 213a, 213b and 214 are formed on an upper end portion, a lower end portion and a middle portion of the bracket 210 to fasten the bracket 210 to the cabinet 11 by using a screw.

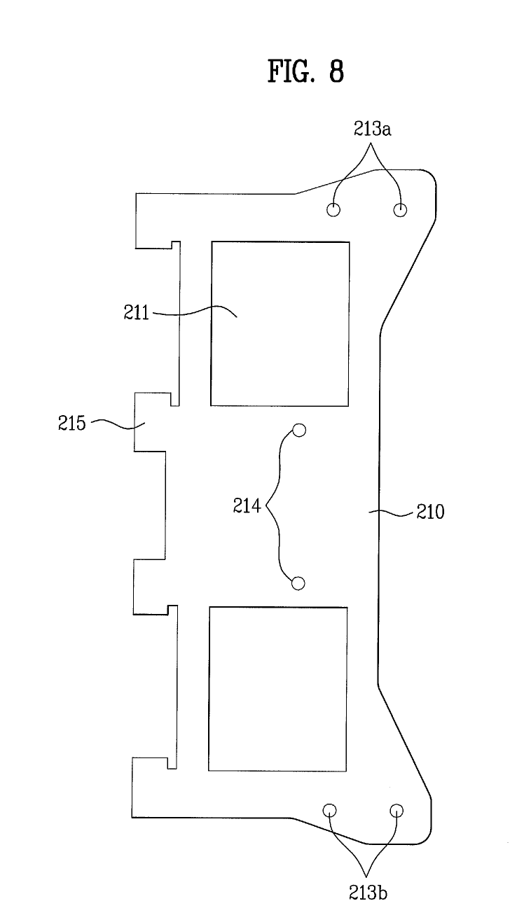

As shown more specifically in FIG. 8, it is preferred that the two fastening holes 213b formed on the lower end portion of the bracket 210 have the same height. It is also preferred that the two fastening holes 213a formed on the upper end portion of the bracket have the same height.

Once the upper and lower fastening holes 213a and 213b are formed at the same height, a fastening unit, for example a screw 240, is fastened to the fastening holes 213a and 213b from an outer direction of the cabinet 11 and the bracket 210 is fastened to the inside of the cabinet 11, such that the screws 240 are positioned at the same height.

Thus, since the load of the door 30 is dispersed to the portion where each screw is fastened, the damage or deformity of the cabinet 11 and the bracket 210 can be prevented efficiently.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A hinge assembly for a door of a laundry device which has a bracket fixed to a cabinet and a hinge arm having a first end rotatably connected to the bracket and a second end connected to a door, wherein at least two fastening holes fastened to the cabinet by a fastening unit are formed on an upper end portion and a lower end portion of the bracket, and the fastening holes of the lower end portion are formed at the same height.

2. The hinge assembly for a door of a laundry device as claimed in claim 1, wherein the fastening holes of the upper end portion are formed at the same height.

3. A hinge assembly for a door of a laundry which has a bracket fixed to a cabinet and a hinge arm having a first end rotatably connected to the bracket and a second end connected to a door, wherein at least two fastening holes fastened to the cabinet by a fastening unit are formed on an upper end portion and a lower end portion of the bracket, and the fastening holes of the upper end portion are formed at the same height.

4. The hinge assembly for a door of a laundry device as claimed in claim 3, wherein the fastening holes of the lower portion are formed at the same height.
